(19) United States
(12) Patent Application Publication
(10) Pub. No.: US 2007/0011609 A1
(43) Pub. Date: Jan. 11, 2007

(54) Configurable, multimodal human-computer interface system and method

(75) Inventors: Malek Adjouadi, Miami, FL (US); Anaelis Sesin, Miami, FL (US); Melvin Ayala, Hollywood, FL (US); Mercedes Cabrerizo, Miami Lakes, FL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Florida International University Board of Trustees, Miami, FL (US)

(21) Appl. No.: 11/176,812

(22) Filed: Jul. 7, 2005

(51) Int. Cl. G06F 3/00; G06K 9/00; G06N 3/02; G06F 15/18; G06E 1/00; G06E 3/00; G06F 9/00; G06F 17/00; G06G 7/00

(52) U.S. Cl. 715/700; 382/103; 706/15

(57) ABSTRACT

Disclosed herein is a method of configuring a human-computer interface system having an eye gaze device that generates eye gaze data to control a display pointer. The method includes selecting a user profile from a user profile list to access an artificial neural network to address eye jitter effects arising from controlling the display pointer with the eye gaze data, training the artificial neural network to address the eye jitter effects using the eye gaze data generated during a training procedure, and storing customization data indicative of the trained artificial neural network in connection with the selected user profile.

### STATEMENT REGARDING FEDERALLY SPONSORED RESEARCH OR DEVELOPMENT

This invention was made with government support under Award No.: CNS-9906600 from the National Science Foundation. The government has certain rights in the invention.

### BACKGROUND OF THE DISCLOSURE

1. Field of the Disclosure

The present disclosure relates generally to human-computer interface (HCl) systems and, more particularly, to an HCl system incorporating an eye gaze tracking (EGT) system.

2. Brief Description of Related Technology

Computer interface tools have been developed to enable persons with disabilities to harness the power of computing and access the variety of resources made available thereby. Despite recent advances, challenges remain for extending access to users with severe motor disabilities. While past solutions have utilized a speech recognition interface, unfortunately some users present both motor and speech impediments. In such cases, human-computer interface (HCl) systems have included an eye gaze tracking (EGT) system to provide for interaction with the computer using only eye movement.

With EGT systems, the direction of a user's gaze positions a mouse pointer on the display. More specifically, the EGT system reads and sends eye gaze position data to a processor where the eye gaze data is translated into display coordinates for the mouse pointer. To that end, EGT systems often track the reflection of an infrared light from the limbus (i.e., the boundary between the white sclera and the dark iris of the eye), pupil, and cornea together with an eye image to determine the point of regard (i.e., point of gaze) as an (x, y) coordinate point on the display or monitor screen of the computer. These coordinates are then translated, and calibrated, to determine the position and movement of the mouse pointer.

Unfortunately, use of EGT systems as the primary mechanism for controlling the mouse pointer and the graphical user interface has been complicated by inaccuracies arising from extraneous head movement and saccadic eye movement. Head movement may adversely affect the pointer positioning process by changing the angle at which a certain display screen position is viewed, and may complicate whether the system is focused and directed toward the limbus. Complicating matters further, the eyes unfortunately exhibit small, rapid, jerky movements as they jump from one fixation point to another. Such natural, involuntary movement of the eye results in sporadic, discontinuous motion of the pointer, or “jitter,” a term which is used herein to generally refer to any undesired motion of the pointer resulting from a user's attempts to focus on a target, regardless of the specific medical or other reason or source of the involuntary motion.

To make matters worse, the jitter effect generally varies in degree and other characteristics between different users. The jitter effect across multiple users may be so varied that a single control scheme to address every user's jitter effects would likely require significant, complex processing. As a result, the system would then be unable to control the mouse pointer position in real time. But without real time control and processing, users would experience undesirably noticeable delays in the movement and positioning of the pointer.

Past EGT systems have utilized hardware or software to address inaccuracies resulting from head movement. Specifically, a head-mounted device is often used to limit or prevent movement of the user's head relative to a camera. But such devices are cumbersome, making use of the EGT system awkward, uncomfortable or impracticable. Head movement has also been addressed through software having an artificial neural network, but such software was limited and not directed to addressing the jitter effects that are also present.

A past EGT system with a head-mounted device calibrated the eye tracking data based on data collected during a calibration stage in which the user attempts to look at five display positions. The calibration stage determined parameters for correlating pupil position with the visual angle associated with the display position. While the user looked at each position, data indicative of the visual angle was captured and later used during operation to calculate eye gaze points throughout the display. Further information regarding the calibration stage of this EGT system is set forth in Sesin, et al., “A Calibrated, Real-Time Eye Gaze Tracking System as an Assistive System for Persons with Motor Disability,” SCI 2003—Proceedings of the 7^{th} World Multiconference on Systemics, Cybernetics and Informatics, v. VI, pp. 399-404 (2003), the disclosure of which is hereby incorporated by reference.

Once calibrated, the EGT system attempted to reduce jitter effects during operation by averaging the calculated eye gaze positions over a one-second time interval. With eye gaze positions determined at a frequency of 60 Hz, the average relied on the preceding 60 values. While this approach made the movement of the pointer somewhat more stable (i.e., less jittery), the system remained insufficiently precise. As a result, a second calibration stage was proposed to incorporate more than five test positions. As set forth in the above-referenced paper, this calibration phase, as proposed, would involve an object moving throughout the display during a one-minute calibration procedure. Attempts by a user to position the pointer on the object during this procedure would result in the recordation of data for each object and pointer position pair. This data would then be used as a training set for a neural network that, once trained, would be used during operation to calculate the current pointer position.

However, neither the past EGT system described above nor the proposed modifications thereto addresses how jitter effects may vary widely between different users of the system. Specifically, the initialization of the EGT system, as proposed, may result in a trained neural network that performs inadequately with another user not involved in the initialization. Furthermore, the EGT system may also fail to accommodate single-user situations, inasmuch as each individual user may exhibit varying jitter characteristics over time with changing circumstances or operational environments, or as a result of training or other experience with the EGT system.

### SUMMARY OF THE DISCLOSURE

In accordance with one aspect of the disclosure, a method is useful for configuring a human-computer interface system having an eye gaze device that generates eye gaze data to control a display pointer. The method includes the steps of selecting a user profile from a user profile list to access an artificial neural network to address eye jitter effects arising from controlling the display pointer with the eye gaze data, training the artificial neural network to address the eye jitter effects using the eye gaze data generated during a training procedure, and storing customization data indicative of the trained artificial neural network in connection with the selected user profile.

In some embodiments, the disclosed method further includes the step of customizing the training procedure via a user-adjustable parameter of a data acquisition phase of the training procedure. The user-adjustable parameter may specify or include one or more of the following for the training data acquisition procedure: a time period, a target object trajectory, and a target object size.

The training step may include the step of averaging position data of a target object for each segment of a training data acquisition phase of the training procedure to determine respective target data points for the training procedure.

In some cases, the disclosed method further includes the step of generating a performance assessment of the trained artificial neural network to depict a degree to which the eye jitter effects are reduced via application of the trained artificial neural network. The performance assessment generating step may include providing information regarding pointer trajectory correlation, pointer trajectory least square error, pointer trajectory covariance, pointer jitter, or successful-click rate. The information provided regarding pointer jitter may then be determined based on a comparison of a straight line distance between a pair of target display positions and a sum of distances between pointer positions.

The disclosed method may further include the step of storing vocabulary data in the selected user profile to support an on-screen keyboard module of the human-computer interface system. Alternatively, or in addition, the method may still further include the step of providing a speech recognition module of the human-computer interface system.

In some embodiments, the disclosed method further includes the step of selecting an operational mode of the human-computer interface system in which the display pointer is controlled by the eye gaze data without application of the artificial neural network.

The selected user profile may be a general user profile not associated with a prior user of the human-computer interface system. The selecting step may include the steps of creating a new user profile and modifying the profile list to include the new user profile.

In accordance with another aspect of the disclosure, a computer program product stored on a computer-readable medium is useful in connection with a human-computer interface system having an eye gaze device that generates eye gaze data to control a display pointer. The computer program product includes a first routine that selects a user profile from a user profile list to access an artificial neural network to address eye jitter effects arising from controlling the display pointer with the eye gaze data, a second routine that trains the artificial neural network to address the eye jitter effects using the eye gaze data generated during a training procedure, and a third routine that stores customization data indicative of the trained artificial neural network in connection with the selected user profile.

The computer program product may further include a routine that customizes the training procedure via a user-adjustable parameter of a data acquisition phase of the training procedure. The user-adjustable parameter may specify or include any one or more of the following for the data acquisition phase: a time period, a target object trajectory, and a target object size.

In some cases, the second routine averages position data of a target object for each segment of a training data acquisition procedure of the training procedure to determine respective target data points for the training procedure.

The computer program product may further include a fourth routine that generates a performance assessment of the trained artificial neural network to depict a degree to which the eye jitter effects are reduced via application of the trained artificial neural network. The fourth routine may provide information regarding pointer trajectory correlation, pointer trajectory least square error, pointer trajectory covariance, pointer jitter, or successful-click rate. The information provided regarding pointer jitter may be determined based on a comparison of a straight line distance between a pair of target display positions and a sum of distances between pointer positions.

In accordance with yet another aspect of the disclosure, a human-computer interface system includes a processor, a memory having parameter data for an artificial neural network stored therein, a display device to depict a pointer, an eye gaze device to generate eye gaze data to control the pointer, and an eye gaze module to be implemented by the processor to apply the artificial neural network to the eye gaze data to address eye jitter effects. The eye gaze module includes a user profile management module to manage the parameter data stored in the memory in connection with a plurality of user profiles to support respective customized configurations of the artificial neural network.

In some embodiments, the eye gaze module is configured to operate in a first mode in which the eye gaze data is utilized to control the pointer via operation of the artificial neural network in accordance with a current user profile of the plurality of user profiles, and a second mode in which the eye gaze data is utilized by the user profile management module to manage the parameter data for the current user profile.

The user profile management module may modify the parameter data to reflect results of a retraining of the artificial neural network in connection with a current user profile of the plurality of user profiles.

The eye gaze module may be configured to provide an optional mode in which the eye gaze data is utilized to generate the control data without application of the artificial neural network.

Implementation of the eye gaze module may involve or include a training data acquisition phase having a user-adjustable time period. Alternatively, or in addition, implementation of the eye gaze module involves or includes a training data acquisition phase during which position data for a target object is averaged over a predetermined time segment prior to use in training the artificial neural network. Alternatively, or in addition, implementation of the eye gaze module involves or includes a training data acquisition phase during which movement of a target object is modified to customize the training data acquisition phase. Alternatively, or in addition, implementation of the eye gaze module involves or includes a training data acquisition phase during which a size of a target object is modified to customize the training data acquisition phase.

In some embodiments, the eye gaze module conducts a performance evaluation assessment to determine a degree to which the eye jitter effects are reduced via application of the artificial neural network.

The user profile management module may be automatically initiated at startup of the eye gaze module.

### BRIEF DESCRIPTION OF THE DRAWING FIGURES

For a more complete understanding of the disclosure, reference should be made to the following detailed description and accompanying drawing in which like reference numerals identify like elements in the figures, and in which:

FIG. 1 is a block diagram of a human-computer interface system having an eye gaze tracking system in accordance with one aspect of the disclosure;

FIG. 2 is a block diagram showing the eye gaze tracking system of FIG. 1 in greater detail and, among other things, the operation of an eye gaze module in accordance with one embodiment of the disclosed human-computer interface system;

FIG. 3 is a flow diagram showing the operation of the eye gaze module of FIG. 2 in accordance with a user profile based jitter reduction technique of the disclosure;

FIG. 4 is a flow diagram showing operational routines implemented by the eye gaze module of FIG. 2 in accordance with one embodiment of the disclosed jitter reduction technique;

FIG. 5 is a flow diagram showing configuration routines implemented by the eye gaze module of FIG. 2 in accordance with one embodiment of the disclosed jitter reduction technique;

FIG. 6 is a flow diagram showing an exemplary data flow in connection with the training of an artificial neural network of the eye gaze module of FIG. 2;

FIGS. 7-9 are simplified depictions of an exemplary display interface generated in connection with the implementation of one or more of the operational and configuration routines of FIGS. 5 and 6;

FIGS. 10 and 11 are simplified depictions of exemplary dialog panels generated via the exemplary display interface shown in FIGS. 7-9 in connection with the implementation of one or more of the operational and configuration routines of FIGS. 5 and 6;

FIGS. 12-15 are simplified depictions of exemplary dialog panels generated via the exemplary display interface shown in FIGS. 7-9 and directed to the management of a plurality of user profiles in accordance with one aspect of the disclosed technique;

FIG. 16 is a simplified depiction of an exemplary display interface generated in connection with the operation of the eye gaze module of FIG. 2 and directed to a performance evaluation assessment of the jitter reduction provided by the artificial neural network;

FIG. 17 is a simplified depiction of an exemplary display interface generated by an on-screen keyboard application of the human-computer interface system of FIG. 1 that includes a vocabulary word panel listing available words alphabetically; and,

FIG. 18 is a simplified depiction of the exemplary display interface of FIG. 17 in accordance with an embodiment that lists the available words in the vocabulary word panel in accordance with a user profile.

While the disclosed human-computer interface system, method and computer program product are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION OF PREFERRED EMBODIMENTS

Disclosed herein is a human-computer interface (HCl) system and method that accommodates and adapts to different users through customization and configuration. Generally speaking, the disclosed system and method rely on a user profile based technique to customize and configure eye gaze tracking and other aspects of the HCl system. The user profiling aspects of the disclosed technique facilitate universal access to computing resources and, in particular, enable an adaptable, customizable multimodal interface for a wide range of individuals having severe motor disabilities, such as those arising from amyotrophic lateral sclerosis (ALS), muscular dystrophy, a spinal cord injury, and other disabilities characterized by lack of muscle control or body movement. Through user profile based customization, an eye gaze tracking (EGT) system of the HCl system is configured to accommodate, and adapt to, the different and potentially changing jitter characteristics of each specific user. More specifically, the user profile based technique addresses the widely varying jitter characteristics presented by multiple users (or the same user over time) in a manner that still allows the system to process the data and control the pointer position in real time.

In accordance with some embodiments, the disclosed technique is utilized in connection with a multimodal platform or interface that integrates a number of systems (i.e., modules or sub-systems), namely: (i) an EGT system for pointer movement control; (ii) a virtual (or on-screen) keyboard for text and editing; and, (iii) a speech recognition engine for issuing voice-based commands and controls. The integrated nature of the system allows each sub-system to be customized in accordance with the data stored in each user profile. Different embodiments of the disclosed system and method may include or incorporate one or more of the sub-systems, as desired. Although some embodiments may not include each sub-system, the disclosed system generally includes the EGT system as a basic interface mechanism to support universal access. Specifically, control of a mouse or other pointer by the EGT system may then enable the user to implement the other modules of the HCl system and any other available tasks. For instance, the EGT system may be used to control the pointer to select the keys of the on-screen keyboard, or to activate the speech recognition engine when commands may be spoken.

The disclosed system and method utilize a broadly applicable technique for customization and configuration of an HCl system. While the disclosed customization and configuration technique is particularly well suited to supporting computer access for individuals having severe motor disabilities, practice of the disclosed technique, system or method is not limited to that context. For example, other contexts and applications in which the disclosed technique, system or method may be useful include any one of a number of circumstances in which users may prefer to operate a computer in a hands-free manner. Furthermore, practice of the disclosed technique is not limited to applications requiring operation or availability of all of the aforementioned modules of the HCl system.

As described below, the disclosed configuration technique utilizes user profile management to enable customization of the interface. More specifically, the user profile based customization involves the configuration, or training, of an artificial neural network directed to reducing the jitter effects arising from use of the EGT system. The separate, dedicated management of each user profile allows the artificial neural network to be trained, and re-trained, for each user, respectively. Moreover, re-training may involve updating the artificial neural network, thereby building upon prior customization and configuration efforts. More generally, a user profile-based approach to reducing jitter effects addresses the user-specific, or user-dependent, nature of jitter (referred to herein as “jitter characteristics”).

The customized artificial neural network enabled by the user profile management and other aspects of the disclosed system and method provide users the capability to interact with a computer in real time with reduced jitter effects. Moreover, the customization of the disclosed system is provided without requiring any user knowledge of artificial neural networks, much less the manner in which such networks are trained. In other words, the reductions in jitter effects via the customized artificial neural network may be accomplished in a manner transparent to the user. In some cases, however, the disclosed system and method may include a performance evaluation or assessment module for individuals or instructors that are interested in determining how well the EGT system is performing, or whether further artificial neural network training is warranted.

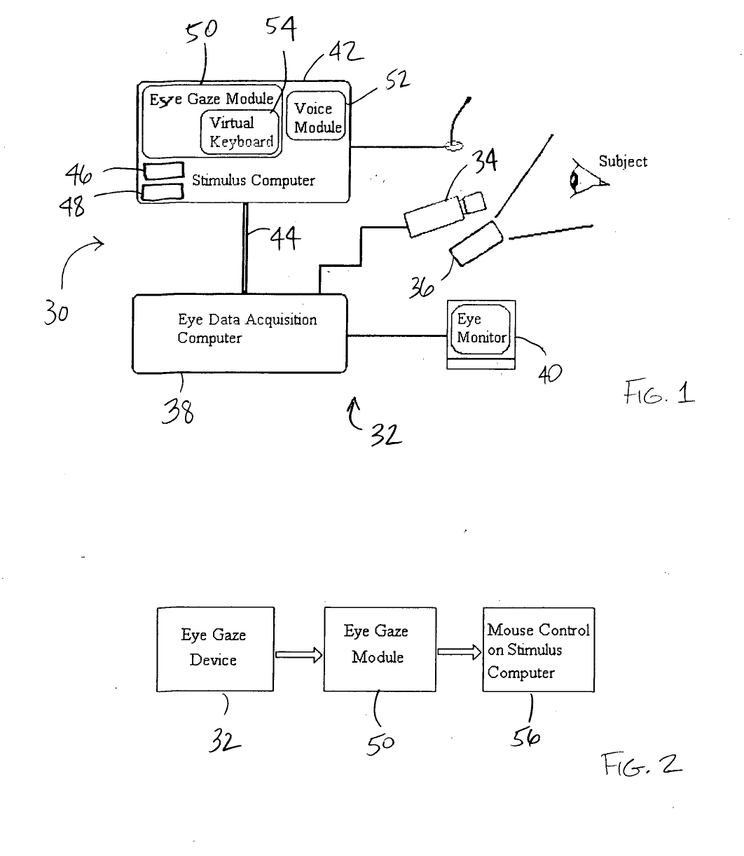

With reference now to the drawing figures, where like elements are identified via like reference numerals, FIG. 1 illustrates an HCl system indicated generally at 30 and having a number of components directed to implementing the disclosed method and technique. The components may be integrated to any desired extent. In this exemplary embodiment, the system 30 includes a dedicated, stand-alone eye gaze device indicated generally at 32. A number of such eye gaze devices are commercially available and compatible for use in connection with the disclosed system and method. Moreover, practice of the disclosed technique is not limited to a particular type of eye gaze device, or limited to devices having a certain manner of operation. In one exemplary embodiment, the eye gaze device 32 includes one of the eye monitoring systems available from ISCAN, Inc. (Burlington, Mass., www.iscaninc.com), such as the Passive Autofocusing Remote Eye Imaging System with 3D Point-of-Regard Calibration.

Generally, the eye gaze device 32 provides data indicative of eye movement and eye gaze direction at a desired rate (e.g., 60 Hz). To that end, the eye gaze device 32 includes a camera or other imaging device 34 and an infrared (IR) or other light source 36. The camera 34 and IR light source 36 may be coupled to, powered by, or integrated to any desired extent with, an eye data acquisition computer 38 that processes video and other data captured by the camera 34. The eye data acquisition computer 38 may take any form, but generally includes one or more processors (e.g., a general purpose processor, a digital signal processor, etc.) and one or more memories for implementing calibration and other algorithms. In some embodiments, the eye data acquisition computer 38 includes a dedicated personal computer or workstation. The eye gaze device 32 may further include an eye monitor 40 to display the video images captured by the camera 34 to facilitate the relative positioning of the camera 34, the light source 36, or the subject. The eye monitor 40 may be used, for instance, to ensure that the camera 34 is directed to and properly imaging one of the subject's eyes. Generally, the eye gaze device 32 and the components thereof may process the images provided by the camera 34 to generate data indicative of the eye gaze direction. Such processing may, but need not, include the steps necessary to translate the data into respective eye gaze coordinates, i.e., the positions on the display at which the user is looking, which may be referred to herein as raw eye data. The processing may also involve or implement calibration or other routines to compensate for head movement and other factors influencing the data.

It should be noted that the terms “eye gaze data” and “raw eye data” are generally used herein to refer to data that has yet to be processed for jitter reduction. As a result, the terms may in some cases refer to the initial data provided by the eye data acquisition computer 38 and, as such, will be used herein in that sense in the context of the operation of the eye gaze device 32. Such data has yet to be translated into the coordinates of a display position. The terms may also be used in the context of jitter reduction processing (e.g., by the aforementioned neural network, as described below). In that context, the terms may also or alternatively refer to the display coordinate data that has yet to be processed for jitter reduction. For these reasons, practice of the disclosed system and method is not limited to a particular format of the data provided by the eye gaze device 32. Accordingly, such data may or may not already reflect display position coordinates.

In the exemplary embodiment utilizing the aforementioned eye monitoring system from ISCAN, Inc., or any other similar eye gaze device, the eye data acquisition computer 38 may include a number of EGT-oriented cards for processing and calibrating the data, including the following ISCAN cards: RK-726PCI; RK-620PC; and, RK-464. The RK-726PCI card provides a pupil/corneal reflection tracking system that includes a real-time image processor to track the center of the subject's pupil and the reflection from the corneal surface, along with a measurement of the pupil size. The RK-620PC card provides an auto-calibration system via an ISA bus real time computation and display unit to calculate the subject's point of regard with respect to the viewed scene using the eye data generated by the RK-726PCI card. The RK-464 card provides a remote eye imaging system to allow an operator to adjust the direction, focus, magnification, and iris of the eye imaging camera 34 from a control console (not shown). More generally, the software implemented by one or more of the cards, or a general purpose processor coupled thereto, is then used to generate the output eye data, or raw eye data (i.e., the eye gaze position data that has yet to be converted to a display coordinate data). The generation of the raw eye data or the operation of the hardware or software involved, is generally known to those skilled in the art, and available from the manufacturer (e.g., ISCAN) or other hardware or software provider. Further details regarding the processing of the raw eye data, however, to address jitter effects are described below in connection with a number of embodiments of the disclosed system and method.

In the exemplary embodiment of FIG. 1, the raw eye data generated by the eye data acquisition computer 38 is provided to a stimulus computer 42 of the disclosed system. The stimulus computer 42 is the computer to be controlled by the user via the EGT system 32. To this end, the raw eye data from the eye data acquisition computer 38 may be provided via a serial connection 44 to control the positioning, movement and other actuation of a mouse or other pointer depicted via a monitor or other display device (not shown) of the stimulus computer 42. The stimulus computer 42 includes one or more processors 46 and one or more memories 48 to execute software routines and implement the disclosed method and technique to further process the raw eye data provided via the serial connection 44. Specifically, an eye gaze module 50 processes the raw eye data to determine the positioning of the mouse pointer in real time, and may be realized in any suitable combination of hardware, software and firmware. Accordingly, the eye gaze module 50 may include one or more routines or components stored in the memories 48. Generally speaking, and as described in greater detail below, the real-time processing of the raw eye data by the eye gaze module 50 involves an artificial neural network configured in accordance with one of a plurality of the user profiles for the purpose of removing, reducing and otherwise addressing jitter effects in the raw eye data.

In addition to the components directed to eye gaze tracking, the system 30 includes a voice, or speech, recognition module 52 and a virtual, or on-screen, keyboard module 54. With the functionality provided by the eye gaze module 50, the voice recognition module 52, and the virtual keyboard module 54, the system 30 provides a multimodal approach to interacting with the stimulus computer 42. The multimodal approach is also integrated in the sense that the eye gaze module 50 may be used to operate, initialize, or otherwise implement the voice recognition module 52 and the virtual keyboard module 54. To that end, the modules 50, 52 and 54 may, but need not, be integrated as components of the same software application. For example, the virtual keyboard module 54 is shown in the exemplary embodiment of FIG. 1 as a component of the eye gaze module 50. In any case, the system 30 may be implemented in a variety of different operational modes, including, for instance, using only the eye gaze module 50, using only the voice recognition module 52, or using the eye gaze module 50 and the voice recognition module 52 simultaneously. During use of the eye gaze module 50, the virtual keyboard module 54 may also be used for typing assistance in word selection or correction.

The eye gaze module 50, the voice recognition module 52, and the virtual keyboard module 54 may be implemented by any combination of software, hardware and firmware. As a result, the voice recognition module 52 may be implemented in some embodiments using commercially available software, such as Dragon Naturally Speaking (Scansoft, Inc., Burlington, Mass.) and ViaVoice (IBM Corp., White Plains, N.Y.). Further details regarding the virtual keyboard module 54 may be found in the above-referenced Sesin, et al. paper. As a further result, the schematic representation illustrating the modules 50, 52, and 54 as separate from the memories 48 is for convenience in the illustration only. More specifically, in some embodiments, the modules 50, 52, 54 may be implemented via software routines stored in the memories 48 of the stimulus computer 42, together with one or more databases, data structures or other files in support thereof and stored therewith. However, practice of the disclosed method and system is not limited to any particular storage arrangement of the modules 50, 52 and 54 and the data and information used thereby. To that end, the data utilized by the modules 50, 52 and 54 may be stored on a device other than the stimulus computer 42, such as a data storage device (not shown) in communication with stimulus computer 42 via a network, such as an intranet or internet. Accordingly, references to the memories 48 herein should be broadly understood to include any number of memory units or devices disposed internally or externally to the stimulus computer 42.

As will be described in greater detail below, the memories 48 store data and information for each user of the system 30 in connection or association with a user profile. Such information and data may include one or more data structures that set forth parameters to configure an artificial neural network, as well as the training data sets underlying such parameters. The data structure for the user profile may include several sections, such as a section for the neural network data and another section for the on-screen keyboard. In some embodiments, the user profile data is stored in the memories 48 in a text format in one or more files. However, other data formats may be used, as desired. Moreover, the user profile related data for each module 50, 52, 54 may be integrated to any desired extent. For example, the user profile related data for operation of the voice recognition module 52 may be separated (e.g., stored in a separate file or other data structure) from the data supporting the other two modules 50, 54.

With reference now to FIG. 2, the operation of the system 30 generally involves the eye gaze device 32 passing the raw eye data to the eye gaze module 50 for processing and subsequent delivery to a mouse pointer controller 56 of the stimulus computer 42. Specifically, the eye gaze device 32 determines eye position coordinate data, such as the point of regard set forth in (X, Y) coordinates. Such eye position coordinate data is provided as a data stream to the eye gaze module 50 for conversion to mouse pointer position coordinates. The mouse pointer position coordinates may be set forth in terms of the position on the display device of the stimulus computer 42 or in any other convenient manner. The output of the eye gaze module 50 may also determine whether a mouse related activity other than movement has occurred, such as a mouse click. As a result, the eye gaze module 50 provides an indication to the mouse controller 56 of whether the user has moved the mouse pointer to a new position or actuated a mouse click (via, for instance, a closing of the eyes). The mouse controller 56 may then act on the indication of the mouse pointer activity. To that end, the mouse controller 56 may interface with the operating system of the stimulus computer 42 or any other module thereof involved in the functionality or rendering of the mouse pointer.

Turning to FIG. 3, the eye gaze module 50 may reside in one of three operational modes, namely a direct mode, an indirect mode, and a profile management mode. Generally speaking, the three operational modes support a customized approach to using eye gaze tracking data to control the mouse pointer. The customization is directed to configuring an artificial neural network to address the jitter effects of each user in accordance with the user's particular jitter characteristics. This technique is enabled by a user profile having customization data for the artificial neural network that was previously generated as a result of a training procedure. As described below, the training procedure is generally based on pointer position data collected during a data acquisition phase of the procedure during which the user attempts to follow a target object with the mouse pointer.

In operation, the eye gaze module 50 receives input data 58 from the eye gaze device 32. The data is provided to a block 60, which may be related to, or present an option menu for, selection of the operational mode. In both the direct and indirect operational modes, the raw eye data is processed to compute the mouse pointer coordinates. Such processing may be useful when adjusting or compensating for different eye gaze devices 32, and may involve any adjustments, unit translations, or other preliminary steps, such as associating the raw eye data with a time segment, target data point, or other data point. More generally, the input data is passed to the block 60 for a determination of the operational mode that has been selected by the user or the stimulus computer 42. For instance, the block 60 may be related to or include one or more routines that generate an option menu for the user to select the operational mode. Alternatively, or in addition, the operational mode may be selected autonomously by the stimulus computer 42 in response to, or in conjunction, a state or variable of the system 30.

If the direct operational mode has been selected, a processing block 62 computes the display pointer coordinates directly from the raw eye gaze data by translating, for instance, the point-of-regard data into the coordinates for a display device (not shown) for the stimulus computer 42. In this way, the eye gaze module 50 may be implemented without the use or involvement of the artificial neural network, which may be desirable if, for instance, an evaluation or assessment of the artificial neural network is warranted.

When the eye gaze module 50 resides in the indirect mode, a processing block 64 computes the display pointer coordinates using a trained artificial neural network. Generally, use of the indirect operational mode stabilizes the movement of the mouse pointer through a reduction of the jitter effect. In most cases, the artificial neural network is customized for the current user, such that the processing block 64 operates in accordance with a user profile. As described further below, the artificial neural network has been previously trained, or configured, in accordance with a training procedure conducted with the current user of the stimulus computer 42. The training procedure generally includes a data acquisition phase to collect the training pattern sets and a network training phase based on the training pattern sets. Implementation of these two phases configures, or trains, the artificial neural network in a customized fashion to reduce the jitter effect for the current user. In this way, the trained neural network takes into account the specific jitter characteristics of the user. Customization data indicative or definitive of the trained neural network (e.g., the neuron weights) is then stored in association with a user profile to support subsequent use by the processing block 64.

Alternatively, or in addition, the processing block 64 may utilize a network configuration associated with a general user profile. The customization data associated with the general user profile may have been determined using data gathered during any number of data acquisition phases involving one or more users, thereby defining a generalized training pattern set. Further details regarding the training of the artificial neural network are set forth herein below.

In some embodiments, the indirect mode processing block 64 may involve or include translating the raw eye data into display pointer coordinates prior to processing via the artificial neural network.

The above-described customized configurations of the artificial neural network and resulting personalized optimal reductions of the jitter effect are obtained via a profile management block 66, which is implemented during the third operational mode of the eye gaze module 50. Generally speaking, implementation of the profile management block 66 is used to create a new user profile or edit an existing user profile in connection with the training or retraining of the artificial neural network. These user profiles may later be used to determine the customized configuration of the artificial neural network for the implementation of the processing block 64.

As shown in FIG. 3, the raw eye data is provided to the profile management block 66 to be used in training pattern sets for the artificial neural network. When the system resides in the profile management mode, the raw eye data is generated during a procedure involving the user following a moving target object depicted via the display device of the stimulus computer (FIG. 1) with his or her gaze. To implement this training procedure, the profile management block 66 (or the software module associated therewith) executes both a data acquisition phase and a network training phase. During the data acquisition phase, display pointer data (or raw eye data) is collected by the profile management block along with position data for a target object being followed by the user. The profile management block 66 may process both the pointer and target data in the manner described below in preparation for use as the training pattern sets for the network training phase, which may be initiated automatically upon completion of the data acquisition phase.

Once all of the training data is collected, the target object may be removed, i.e., no longer depicted, such that the user may begin to use the mouse pointer for normal tasks. While the artificial neural network is being trained (or re-trained), control of the mouse pointer position may be in accordance with either the direct or indirect modes. For instance, if the profile management block 66 is being implemented to update an existing user profile, the artificial neural network as configured prior to the training procedure may be used to indirectly determine the mouse pointer position. If the user profile is new, then either the general user profile may be used or, in some embodiments, control of the mouse pointer may return to the direct mode processing block 62. Either way, the system may concurrently implement multiple processing blocks shown in FIG. 3. For this reason, the network training phase may involve processing steps taken in the background, such that the user may operate the stimulus computer 42 during the training phase.

In the exemplary embodiment of the eye gaze module 50 shown in FIG. 3, operation in any one of the three modes associated with the processing blocks 62, 64, and 66 results in the generation of mouse pointer coordinate data 68.

The user profile management module that implements the processing block 66 may be automatically initiated at system startup to, for instance, establish the user profile of the current user. Alternatively, or in addition, the user profile may be established in any one of a number of different ways, including via a login screen or dialog box associated with the disclosed system or any other application or system implemented by the stimulus computer 42 (FIG. 1).

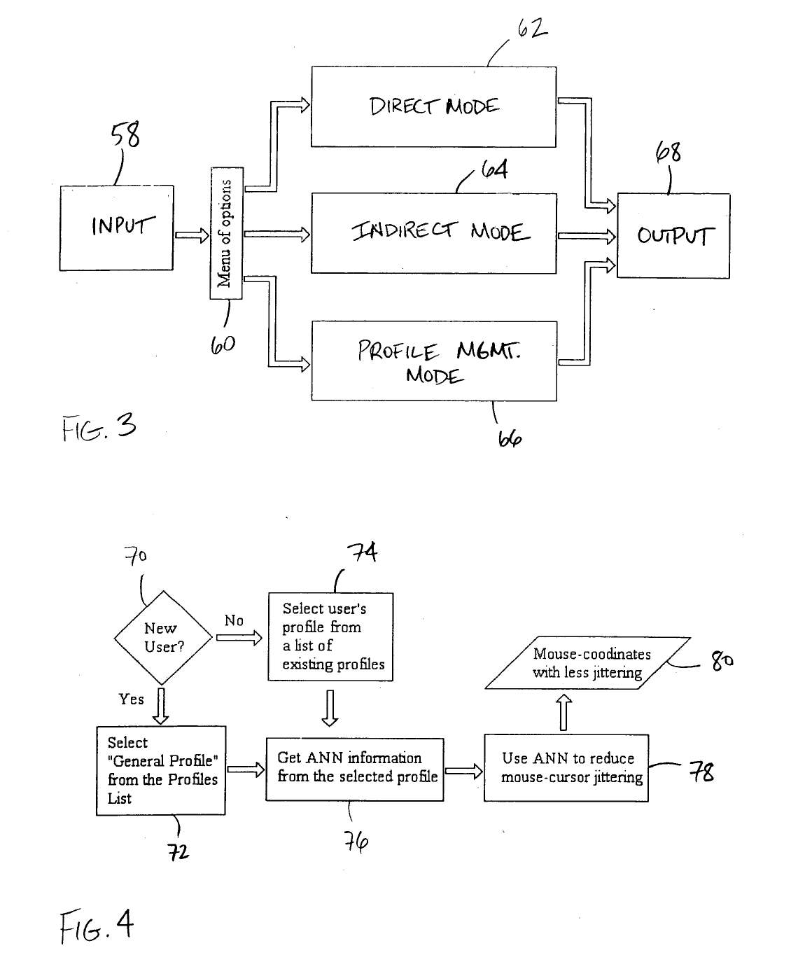

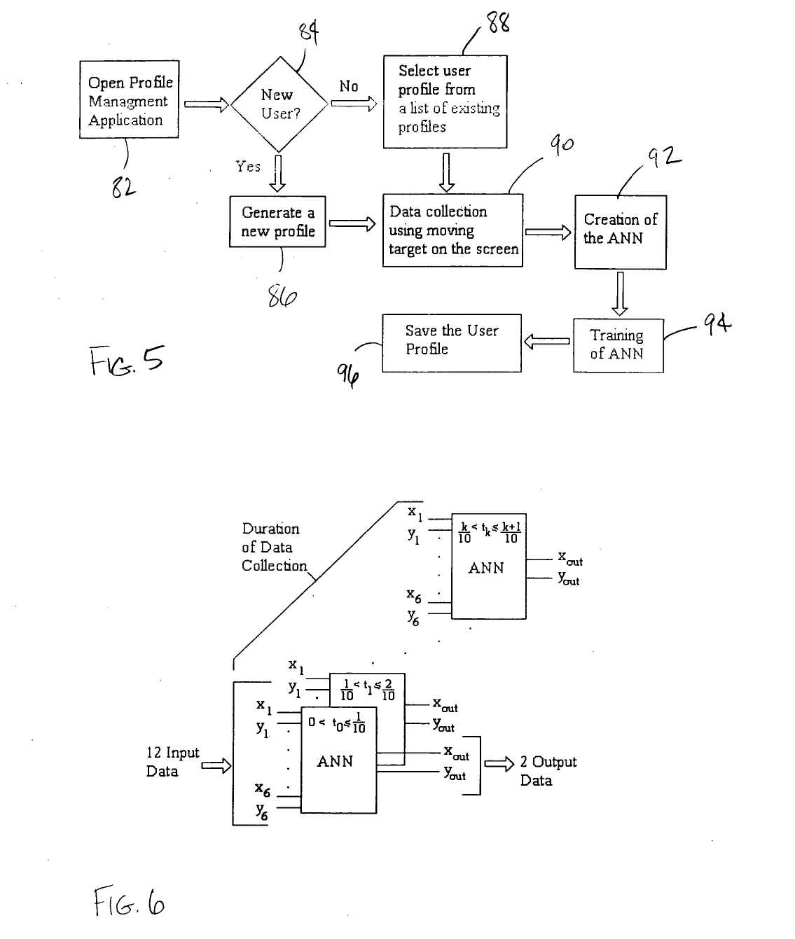

FIG. 4 shows the processing steps or routines implemented by the eye gaze module 50 when executing the indirect mode processing block 64 in accordance with an exemplary embodiment. At the outset, a decision block 70 determines whether the current user is a new or first time user of the system 30. The determination may be made based on a login identification or any other suitable identification mechanism that may, but need not, identify the user by a user name. The user, however identified, may be determined to be new if the user is not associated with a user profile previously created or stored by the eye gaze module 50. If no such user profile exists, control may pass to a block 72 that selects a general profile from a profile list accessed by the eye gaze module 50. When the user is associated with a known user profile, control passes to a block 74 that selects the appropriate user profile from the profile list. Generally speaking, the user profile list may take any form and need not be a list presented or rendered on the display device of the stimulus computer 42. The user profile list may, therefore, correspond with, or be located in, a database or other data structure in the memories 48. Moreover, the user profile list may contain zero, one, or more user profiles indicated by data or information stored in such data structures. In some embodiments, however, the profile list includes, at the very least, a general profile from which additional user specific profiles may be generated.

As shown in the exemplary embodiment of FIG. 4, the selection of a user profile may happen automatically, and need not involve the selection of a user option or a response to a user prompt rendered on the display device. Such autonomous selection of the user profile may be useful in situations where the jitter effect inhibits the use of the graphical user interface presenting such options or prompts. The selection of a user profile by one of the blocks 72, 74 may accordingly correspond with a step taken by the routine implemented by the eye gaze module 50 in response to any state or variable established via operation of the stimulus computer 42.

After selection of the user profile, the processing block 64 of the eye gaze module 50 retrieves in a block 76 the customization data, parameters and other information that define the artificial neural network for the selected profile. Specifically, such data, parameters or information may be stored in connection with the selected profile. Next, a block 78 implements or executes the artificial neural network in accordance with the customization data, parameters or other information to reduce the jitter effect by computing adjusted mouse pointer coordinate data. Further details regarding the operation of the artificial neural network as configured by the customization data are set forth herein below. The output of the artificial neural network is provided in a block 80 as mouse pointer coordinate data in real time such that the mouse pointer exhibits the reduced jitter effect without any processing delay noticeable by the user.

The selection of the general profile via the block 72 or otherwise in connection with embodiments other than the embodiment of FIG. 4 may provide a convenient way to initially operate the eye gaze module 50 without any training or retraining. More specifically, the general profile may be generated using data collected from several subjects prior to the use or installation of the eye gaze module 50 by the current user. Such data was then used to train the artificial neural network, thereby configuring the eye gaze module 50 in a generalized fashion that may be suitable for many users. The current user without his or her own user profile may then conveniently test the system 30 using the general profile and implement a performance assessment or evaluation, as described herein below. If the mouse pointer movement could benefit from additional stability, the user may then opt to switch the operational mode to the profile management mode to create a personalized profile and, thus, a customized neural network and HCl system.

FIG. 5 provides further details regarding operation in accordance with one embodiment in connection with the profile management mode 66 (FIG. 3), which may, but need not, include or incorporate the execution of a separate software application opened in a block 82. In either case, the routine or steps shown in FIG. 5 and other processing associated with user profile management may be considered to be implemented by a profile management module. Once the profile management module is initiated, control passes to a decision block 84 that determines whether the current user is a new user. If the current user is a new user, a new profile is generated in a block 86. Otherwise, control passes to a block 88 that selects the user profile associated with the current user from a user profile list of existing profiles. In this way, users may update an existing user profile to accommodate changes in jitter characteristics. More generally, implementation of the user profile management module supports the collection of training data for the artificial neural network to be configured or customized for the current user. To that end, and to begin the above-identified training procedure, data is collected in a block 90 that generates the moving target on the display device of the stimulus computer 42 (FIG. 1). Implementation of the block 90 continues during this training data acquisition phase, which may have a user specified duration. Further details regarding this phase of the training procedure are set forth below in connection with an exemplary embodiment.

In some embodiments, implementation of the profile management module includes the creation of the artificial neural network in a block 92 following the completion of the data collection. The creation may happen automatically at that point, or be initiated at the user's option. The artificial neural network may have a predetermined structure, such that the configuration of the artificial neural network involves the specification of the neuron weights and other parameters of a set design. Alternatively, the user may be provided with an opportunity to adjust the design or structure of the artificial neural network. In one exemplary embodiment, however, the artificial neural network includes one hidden layer with 20 hidden units with sigmoidal activation functions. Because the outputs of the network are X and Y coordinates, two output units are needed (xₒᵤₜ, yₒᵤₜ).

Training of the artificial neural network is then implemented in a block 94 associated with the training phase of the procedure. Practice of the disclosed system and method is not limited to any particular training sequence or procedure, although in some embodiments training is implemented with five-fold cross validation. Moreover, the training data set need not be of the same size for each user. Specifically, in some embodiments, the user may adjust the duration of the data collection to thereby adjust the size of the data set. Such adjustments may be warranted in the event that the artificial neural network converges more quickly for some users. For that reason, the user may also specify or control the length of time that the artificial neural network is trained using the collected training data. For instance, some embodiments may provide the option of halting the training of the artificial neural network at any point. To facilitate this, an evaluation or assessment of the performance of the artificial neural network may be helpful in determining whether further training in warranted. Details regarding an exemplary evaluation or assessment procedure are set forth below. Once the training is complete, the parameters of the artificial neural network resulting from the training are stored in connection with the current user profile in a block 96.

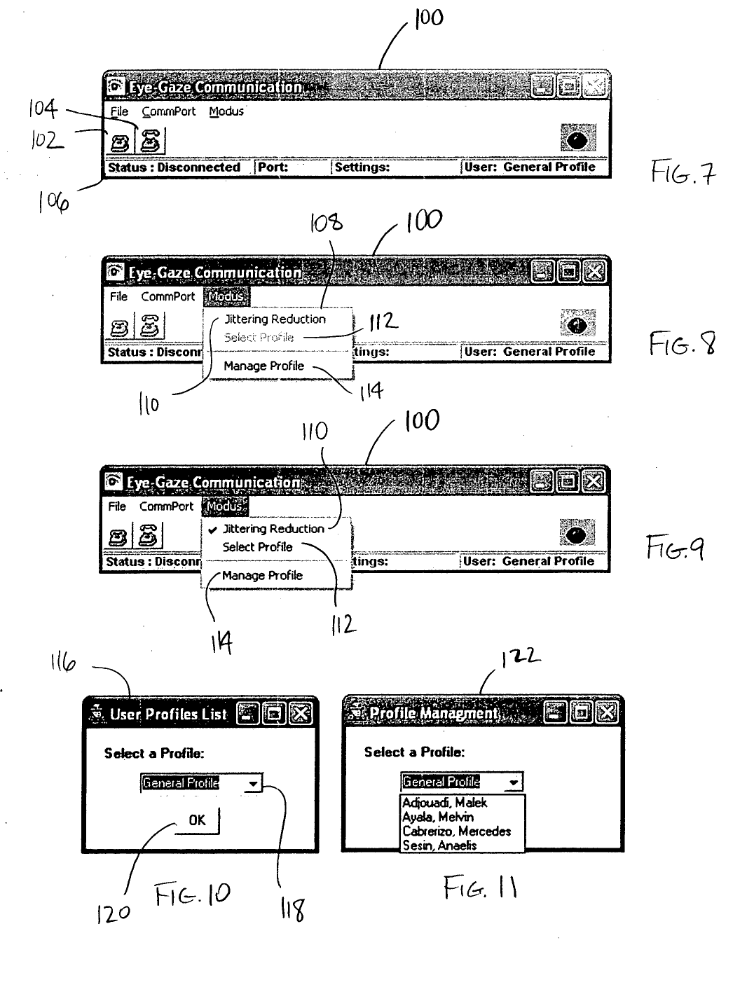

With reference now to FIG. 6, the data collection process involves a moving target, such as a button, rendered on the display device of the stimulus computer 42 (FIG. 1), which the user follows throughout the data acquisition phase. As the user looks at the button, the mouse pointer coordinates generated by the eye gaze device 32 are taken as the input data for the training of the artificial neural network, while the actual display coordinates of the button are taken as the artificial neural network target data. Such data may be collected for a duration of, for instance, about one to two minutes, which may then be divided into time segments or sample frames of, for instance, one-tenth of a second. In embodiments where the eye gaze device generates mouse pointer coordinate data points at a rate of 60 Hz, each segment corresponds with six separate coordinate pairs shown in FIG. 6 as (x₁, y₁) through (x₆, y₆) for a total of twelve input data points for each training pattern. Of course, practice of the disclosed system and method is not limited to the aforementioned, exemplary sample frame sizes, such that alternative embodiments may involve an artificial neural network having more or less than the twelve input data points identified in FIG. 6. Modifications to the sample frame size and other parameters of the data collection process may especially be warranted in alternative embodiments using an eye gaze device that generates data at a different rate.

As shown in the exemplary embodiment of FIG. 6, training patterns are extracted for the artificial neural network with the aforementioned sampling window size of six points. The effective sampling frequency for the artificial neural network is therefore 10 Hz. For each segment, the target data point (xₒᵤₜ, yₒᵤₜ) is set to the average location of the moving button within that time frame.

The number of training patterns generated during the data collection process is defined as:

$$k = \frac{duration\_in \_seconds}{sampling\_rate} = size\_of \_training \_set$$

where the sampling rate equals one-tenth of a second. For example, if the user follows the button for a two-minute data acquisition period, the training set is composed of 1200 training patterns.

Given the size of the data collection set, the artificial neural network may converge very quickly during training. In such cases, the training may stop automatically. The manner in which the determination to stop the training occurs is well known to those skilled in the art. However, in some embodiments, the determination may involve an analysis of network error, where a threshold error (e.g., less than five percent) is used. To that end, a quick comparison of the data for the following time segment with the calculated output given the current weights of the artificial neural network may be used to compute the error. Alternatively, or in addition, the determination as to whether the artificial neural network has converged may involve checking to see whether the artificial neural network weights are not changing more than a predetermined amount over a given number of iterations.

Further details regarding the design, training and operation of the artificial neural network and the EGT system in general (e.g., the actuation of mouse clicks) may be found in the following papers: A. Sesin, et al., “Jitter Reduction in Eye Gaze Tracking System and Conception of a Metric for Performance Evaluation,” WSEAS Transactions on Computers, Issue 5, vol., 3, pp. 1268-1273 (November 2004); and, M. Adjouadi, et al., “Remote Eye Gaze Tracking System as a Computer Interface for Persons with Sever Motor Disability,” Proceedings of ICCHP, LNCS 3118, pp. 761-769 (July 2004), the disclosures of which are hereby incorporated by reference.

Generally speaking, the eye gaze module 50 and other components of the disclosed system, such as the user profile management module, may be implemented in a conventional windows operating environment or other graphical user interface (GUI) scheme. As a result, implementation of the disclosed system and practice of the disclosed method may include the generation of a number of different windows, frames, panels, dialog boxes and other GUI items to facilitate the interaction of the user with the eye gaze module 50 and other components of the disclosed system. For example, FIGS. 7-9 present an eye gaze communication window 100 generated in connection with an exemplary embodiment. The eye gaze communication window 100 may constitute a panel or other portion of a display interface generated by the disclosed system having a main window from which panels, sub-windows or other dialog boxes may be generated. More generally, the window 100 presents one exemplary approach to providing a number of menus or options to the user to interface with, and control, the eye gaze module 50. For instance, the window 100 includes a pair of buttons 102, 104 to control, and signify the status of, the connection of the eye gaze device 32 (FIG. 1) to the stimulus computer 42 (FIG. 1). The status of the connection may also be shown in a frame 106 of the window 100 adjacent to a number of other frames that may identify other status items or settings, such as the current user profile.

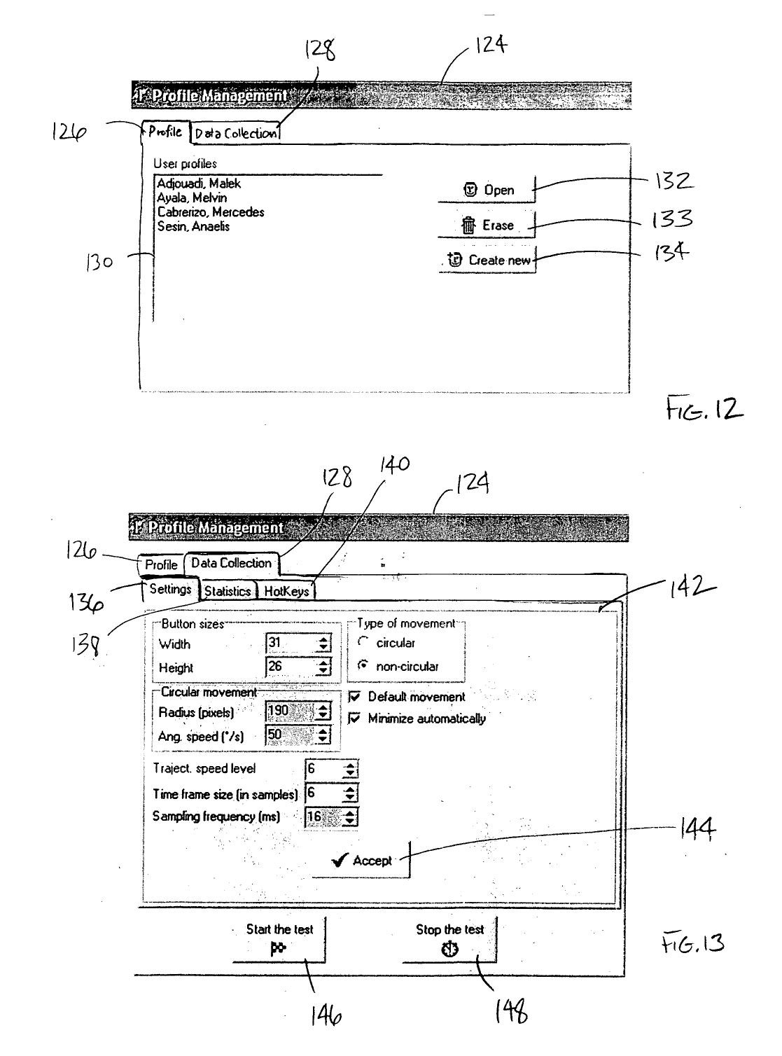

The eye gaze communication window 100 presents a number of drop down menus to facilitate the identification of communication and other settings for the eye gaze module 50, as well as, more generally, the interaction with the eye gaze device 32. A “Modus” Dropdown menu 108 shown in FIGS. 8 and 9 generally provides the user with the option of selecting the operational mode of the eye gaze module 50. In this exemplary embodiment, the drop down menu 108 provides the option of toggling between the direct and indirect modes of operation by selecting a “jittering reduction” item 110. FIG. 8 shows the jittering reduction item 110 as not selected, such that the eye gaze module 50 operates in the direct mode. In contrast, FIG. 9 shows the jittering reduction item 110 as selected, such that the eye gaze module operates in the indirect mode. When the jittering reduction option is not activated, a “select profile” item 112 in the drop down menu 108 is shaded or otherwise rendered in the conventional manner to indicate that the item is not available (as shown in FIG. 8). Lastly, the dropdown menu 108 provides a “manage profile” item 114 that may be used to initiate the profile management module or application described in connection with FIG. 5.

In operation, if the user selects the “jittering reduction” option by clicking on the item 110, a check mark or other indication may appear next to the item 110 as shown in FIG. 9. Once jittering reduction is selected, a user profile may be selected by clicking on the select profile option 112, if the user has yet to do so. In embodiments having a general profile to support new users or users that have elected not to train the artificial neural network, the jittering reduction option may be selected without the specification of a user profile.

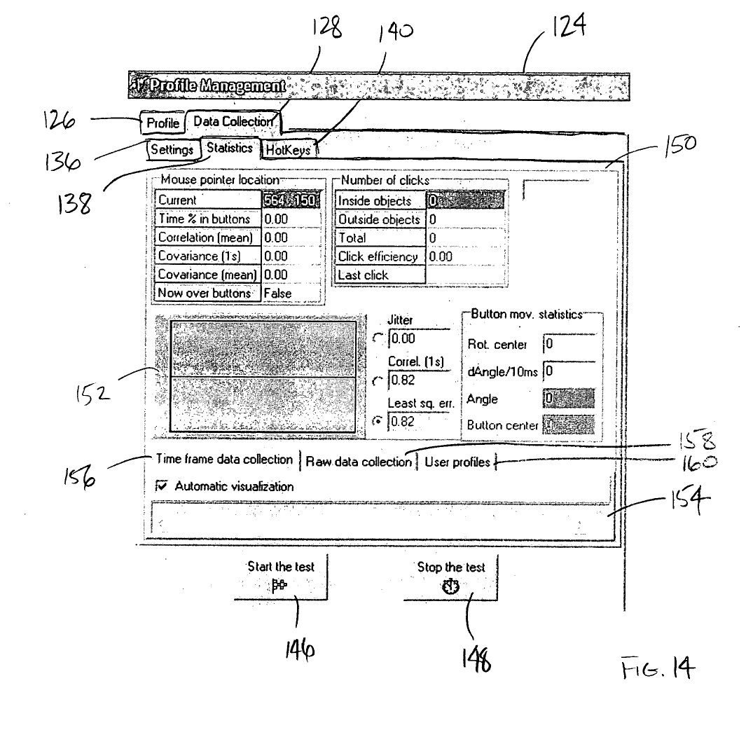

As shown in FIG. 10, selection of the select profile item 112 (FIG. 9) may generate a “user profiles list” window 116 to facilitate the selection of a profile. The window 116 includes a drop down menu 118 that displays each of the user profiles that have previously been created and stored in one of the memories 48, such as a database or file dedicated thereto. In some cases, a general profile may be the first listed profile and also constitute a default profile in the event that an individualized user profile is not selected. Using the drop down menu 118, the individualized or personalized user profiles (i.e., the profiles other than the general profile) may be listed in alphabetical order. The user may then select the desired user profile and click an “OK” button 120, which causes the eye gaze module 50 to load all the information necessary to apply the jittering reduction algorithm for that particular user profile. As mentioned above, the selected user profile may then be displayed in the lower right hand corner of the eye gaze communication window 100.

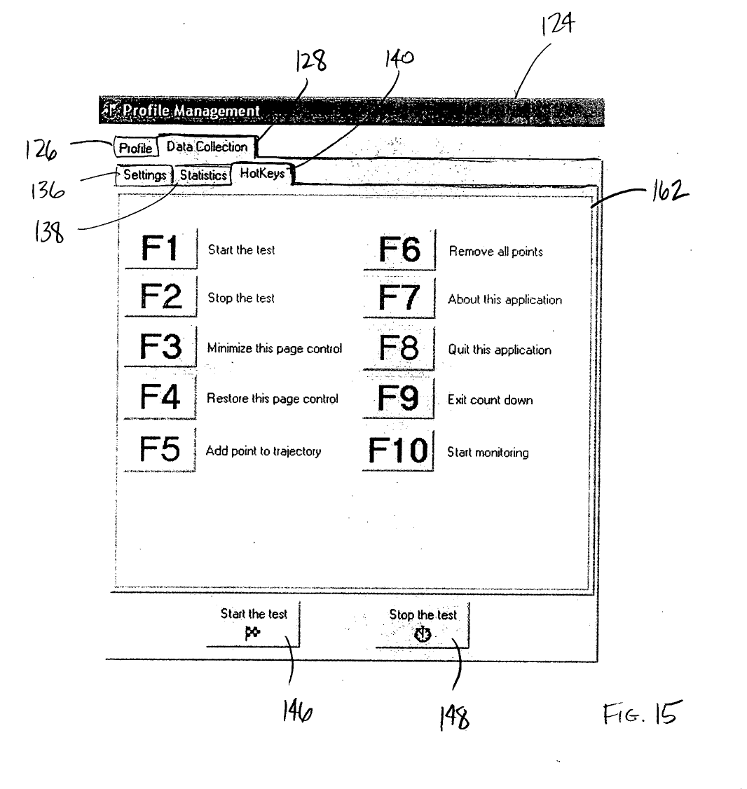

FIG. 11 shows an exemplary profile management window 122 that may be generated via the selection of the manage profile item 114 provided to the user via the eye gaze communication window 100 of FIG. 8. The profile management window 122 may be the same as the window 116 provided to support the selection of a user profile, in the sense that the window 122 also provides the user with the opportunity to select the profile to be managed. As a result, the window 122 may have a drop down menu and “OK” button similar to the menu 118 and button 120 shown in FIG. 10. Generally speaking, the profile management functionality supported by the window 122 allows the user to update or otherwise edit an existing profile by selecting the name or other indication associated therewith. Once the user profile is selected, the user profile management module or application may then initiate the data collection process.

FIG. 12 shows a profile management window 124 that may be alternatively or additionally generated by the profile management module to both facilitate the selection of a user profile as well as control the data collection procedure. To these ends, the window 124 includes a profile tab 126 and a data collection tab 128. Selection of the profile tab 126 generates a panel 130 within the window 124 that lists each of the user profiles available for management. Control buttons 132-134 may also be provided within the window 124 to facilitate the opening, erasing or creation of a user profile, respectively.

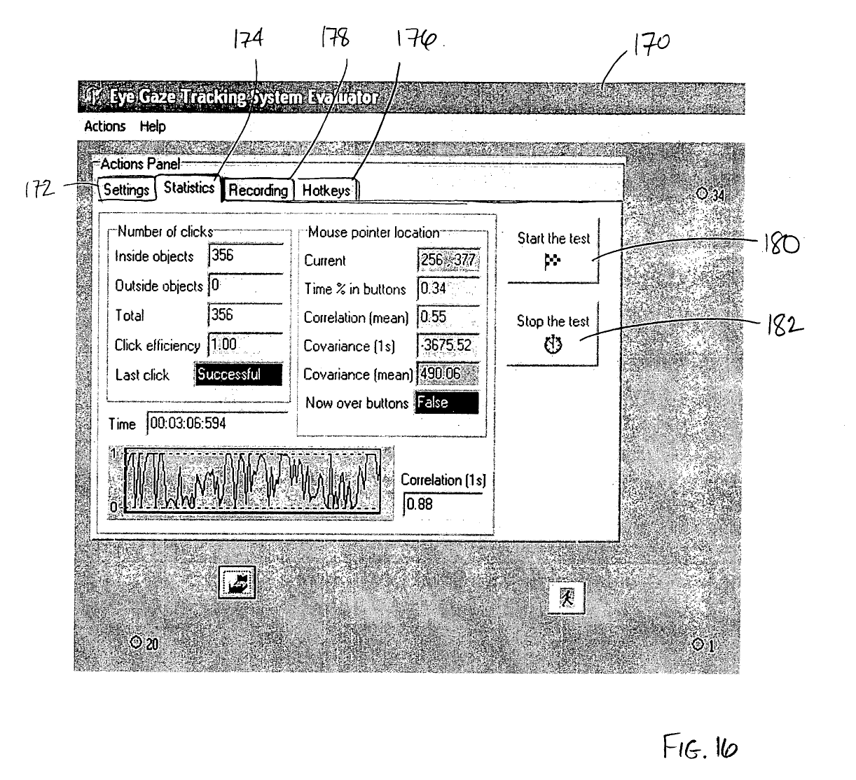

Turning to FIG. 13, the profile management window 124 is shown after the selection of the data collection tab 128, which is generally used to control and customize the data collection procedure. To that end, selection of the data collection tab 128 generates the display of three additional tabs, or sub-tabs, namely a settings tab 136, a statistics tab 138 and a hotkeys tab 140. With the settings tab 136 selected, the window 124 displays a panel 142 that includes or presents a number of parameters for modification or customization. For example, the size of the target button may be adjusted by changing its width or height. This option may assist users with poor eyesight. Moreover, the type of movement for the trajectory of the button during the training session may be modified, for example, between either circular or non-circular motion. In the event that circular movement is selected, the radius and angular speed of the movement may also be specified. Of course, these trajectory types are exemplary in nature and, more generally, providing non-circular trajectories (e.g., triangular) forces the user to follow abrupt changes in direction, which may help generate a stronger training pattern set. Furthermore, the speed of the button motion, the time frame size, the number of samples, and the sampling frequency may also be specified. In addition to the aforementioned properties of the target (e.g., size, trajectory and speed), the panel 142 further provides check boxes for selecting a default movement option and a minimization option. The default movement option, if selected, may provide a predetermined motion pattern, as opposed to a randomly determined pattern that may change from implementation to implementation. The minimization option may be directed to minimizing the window 124 upon initiation of the data collection process.

Other embodiments may set forth additional or alternative properties of the data collection phase to be specified or adjusted to meet the needs of the user.

Once the user clicks an “Accept” button 144 to accept the settings specified in the panel 142, the user may then start the data collection (herein referred to as the “test”) by clicking or selecting a button 146. Afterwards the user may stop the test by clicking or selecting a button 148, provided of course the window 124 is still displayed during the data collection process. In the event the window 124 was minimized via selection of the check box described above, a hotkey may be used to stop the test, as described further below.

With reference now to FIG. 14, selection of the statistics tab 138 generates a panel 150 within the window 124. The panel 150 generally presents data and information regarding the stability of the system or, in other words, data and information directed to an assessment or evaluation of the performance of the artificial neural network. In some embodiments, the panel 150 (or one similar thereto) may also be used to present such data and information in connection with the raw eye data not processed by the neural network (e.g., the data generated in the direct mode). Such information may be set forth in a number of tables, such as a table directed to the location of the mouse pointer, a table directed to the number and location of the mouse clicks during data collection, and statistics regarding the button movement. The panel 150 may also include a plot area 152 for displaying variables in real time, such as (i) a representation of the amount of jitter, (ii) correlation values, or (iii) leased squares error versus time, depending on the selection thereof to the right of the plot area 152. More specifically, the observation variables available for plotting or other display may include pointer trajectory correlation, pointer trajectory least square error, pointer trajectory covariance, degree of pointer jitter, and a rate of successful target clicks. More generally, the statistical information provided via the panel 150 is not limited to the variables or parameters shown in the exemplary embodiment of FIG. 14, but rather may provide any information relevant to assessing the performance of the disclosed system and the use thereof by the current user.

The window 124 also provides a set of three tabs to control the data displayed in a panel 154 having scroll bars to facilitate the visualization of data values to be displayed. Specifically, selection of a time frame data collection tab 156 generates a presentation of the time frame data collected during the process in the panel 154. Similarly, selection of a raw data collection tab 158 allows the user to view the raw eye data generated by the eye gaze device 32 (FIG. 1) during the data collection process. Lastly, selection of a user profiles tab 160 allows the user to view the available user profiles for management and modification. More generally, the window 124 may be viewed during the data collection (i.e., after the button 146 has been clicked) such that the statistical data provided via the panel 150 and the panel 154 can be viewed during the process.

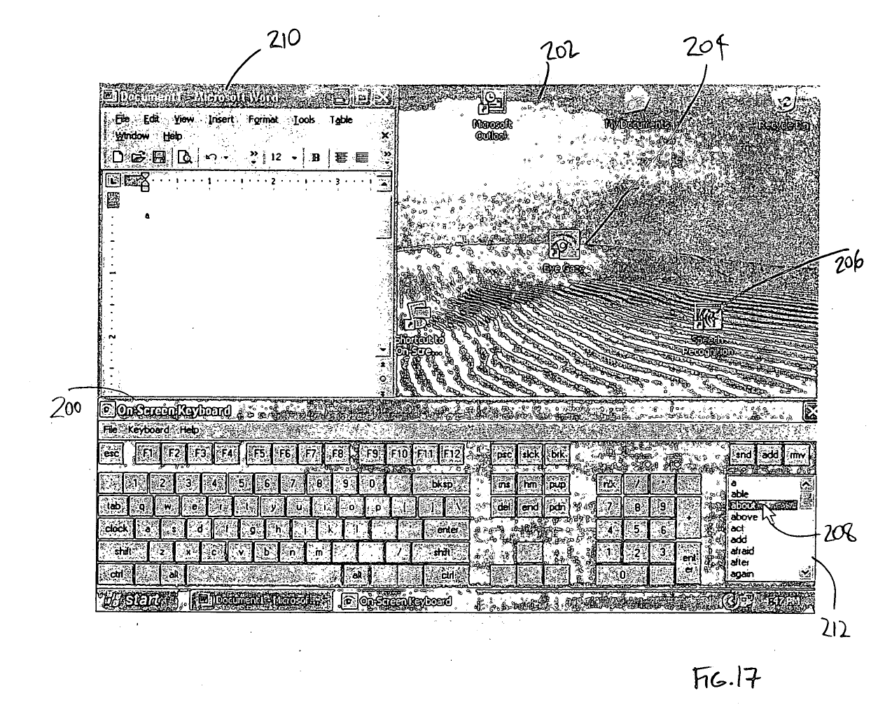

FIG. 15 shows the window 124 after the hotkeys tab 140 has been selected, which causes a panel 162 to be displayed. Generally, the selection of the hotkeys tab 140 is used to display an identification of the functionality associated with each hotkey defined by the profile management module. To that end, the panel 162 includes a set of buttons corresponding with the available hotkeys, together with respective descriptions of the functionality. The buttons therefore present the user with virtual hotkeys for actuation of the functionality without having to use the hotkeys located on a keyboard of the stimulus computer 42 (FIG. 1).

The functionality provided by the hot keys may, but need not, correspond with the functions identified in the exemplary embodiment of FIG. 15. Nonetheless, some functions that may be useful include starting the test or data collection procedure (F1), stopping the test or data collection procedure (F2), minimizing the profile management window 124 (F3), restoring the profile management window 124 (F4), and adding or removing points from the target button trajectory. Hotkeys may also be used to exit or quit the profile management module, view information about the profile management module, start performance (or other data) monitoring, and exit an initial countdown. When the data collection is started, a countdown of, for instance, ten seconds may be executed before the target starts to move on the display screen. This countdown may be useful to give the user some time to prepare for the test or data collection process. The exit countdown hotkey may be provided to allow the user to skip the countdown and start the test immediately.

The start monitoring hotkey may be one way in which the performance assessment or evaluation data is continued after the data collection phase and, more generally, the training procedure. For example, selection of the start monitoring hotkey may cause the profile management module (and the statistical data displays thereof) to remain open after the data collection phase is finished. In this way, the user can observe, for instance, an animation chart showing data directed the degree of jitter in real time, thereby evaluating the performance of the neural network.

FIG. 16 shows an alternative embodiment in which an eye gaze tracking system evaluator window 170 is generated by the profile management module or the eye gaze module 50. The window 170 may be generated as an alternative to the profile management window 124 or, alternatively, generated in addition to the profile management window 124 when, for instance, performance evaluation or assessment is desired outside of the profile management context. Accordingly, the window 170 may be generated and utilized during operation in either the direct or indirect data processing modes. As shown in FIG. 16, the eye gaze tracking system evaluator window 170 presents information and data similar to that shown by the profile management window 124 through the selection of similar tabs. Specifically, the window 170 also includes a settings tab 172, a statistics tab 174, and a hotkeys tab 176. The window 170 further includes a recording tab 178 tab that may be selected by a user to specify the time period for collecting training data for the artificial neural network. Outside of specifying parameters such as the data collection time period, the window 170 may be used to evaluate or assess the performance of the artificial neural network as it is used to reduce jitter effects for the mouse pointer. To that end, buttons 180 and 182 are provided via the window 170 to start and stop the evaluation or assessment test, in much the same fashion as the buttons 146 and 148 of FIGS. 13-15.

Information regarding computation of the degree of jitter, the correlation between the calculated mouse pointer position and the actual mouse pointer position, and the least square error associated with that difference may be found in the above-referenced papers. With regard to the jitter metric, the Euclidean distance between the starting point (x₁, y₁) and the end point (xₙ, yₙ) or, the above example, (x₆, y₆), is considered to be the optimal trajectory—a straight line with no jitter. The degree of jittering may be regarded as a percentage of deviation from this straight line during each sample frame or time segment. One equation that may be used to express this approach to measuring the degree of jitter is set forth below, where its value decreases to 0 when the mouse pointer moves along a straight line.

$$J = \frac{{\sum }_{i = 2}^{6} {d}_{i - 1 , i} - {d}_{1 , 6}}{{d}_{1 , 6}}$$

In the above equation, the sum of the distances between consecutive pointer positions, dᵢⱼ-d₁₆, is computed for a given time segment having six consecutive mouse pointer locations. In this way, the jittering degree is computed by comparing the sum of individual distances between consecutive points (e.g., the distance between points 1 and 2, plus the distance between points 2 and 3, plus the distance between points 3 and 4, etc.) with the straight line distance between starting and ending points for the six-point time frame.

Practice of the disclosed system and method is not limited, however, to any one equation or computation technique for assessing the performance of the artificial neural network. On the contrary, various statistical techniques known to those skilled in the art may be used in the alternative to, or in addition to, the technique described above. Moreover, conventional statistical computations may be used to determine the correlation, covariance, and covariance-mean data to be displayed in the windows 124 and 170.

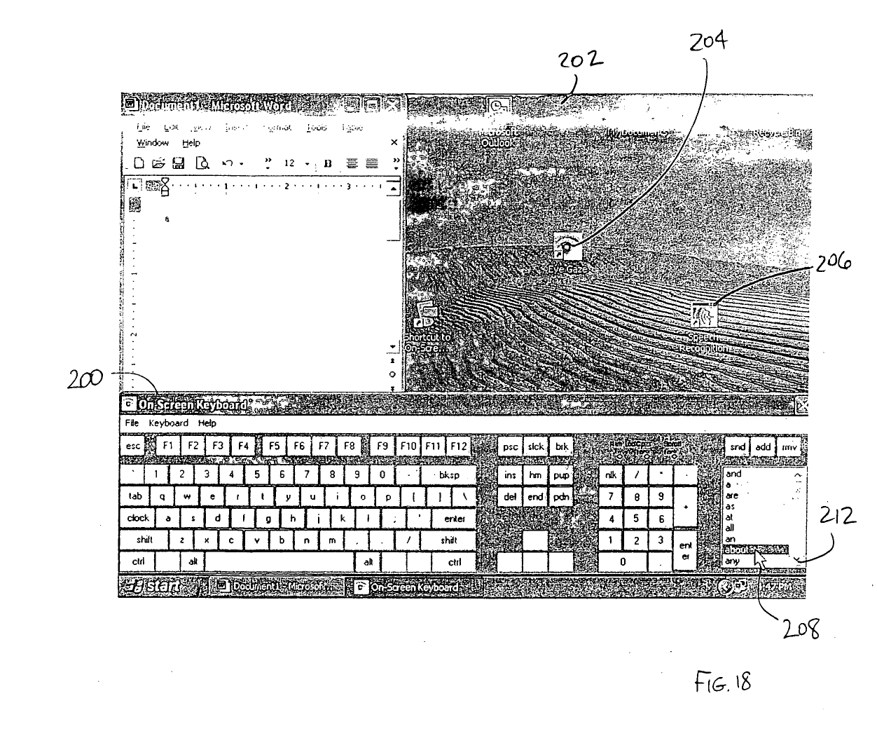

One advantage of the above-described user profile based approach to customizing the system 30 (FIG. 1) and its use of an artificial neural network to address jitter effects is that the same user profile may also have stored in connection therewith information or data to support customized features of other modalities of the disclosed system. Specifically, and in reference to FIGS. 17 and 18, each user profile may have information or data stored in support of the implementation of an on-screen keyboard 200 and a speech (or voice) recognition module. Shown in FIGS. 17 and 18 is an exemplary display screen 202 rendered via the display device of the stimulus computer 42 (FIG. 1), which may be implementing one or more of the eye gaze module 50, the on-screen keyboard 200, and the speech recognition module. Because the eye gaze module 50 and the speech recognition module may be implemented in the background (i.e., without one or more windows currently displayed to the user), the display screen 202 only shows icons 204 and 206 for initiating the implementation of the eye gaze module 50 and the speech recognition module, respectively. In the event that the eye gaze module 50 has been initiated via actuation of the icon 204, the position and movement of a pointer 208 may be controlled with reduced jitter effect using the above-described components of the system 30. While the speech recognition module may also be used to control the position and movement of the pointer 208 via commands (e.g., move up, move down, move right, click), the speech recognition module may be used to insert text into a document, file, or other application interface. For example, after initiating the speech recognition module by actuation of the icon 206, text may be inserted into a word processing document window 210.

A panel 212 of the on-screen keyboard 200 provides a customized vocabulary list specifying words in either alphabetical order or in order of statistical usage. The statistical data giving rise to the latter ordering of the vocabulary words may be stored in connection with the user profile associated with the current user. Accordingly, the panel 212 may include a list of recently typed or spoken words by the user associated with the current user profile.

More generally, use of the eye gaze module 50 enables the user to implement the on-screen keyboard 200 and initiate the execution of any one of a number of applications or software applications or routines available via the user interface of the stimulus computer 42 (FIG. 1). To that end, the pointer controlled via the eye gaze module 50 may take on any form suitable for the application or user interface in operation. The pointer may be a mouse pointer, cursor or any other indicator tool displayed or depicted via the user interface, as well as any other display item having a position controlled by the EGT system. Accordingly, the term “display pointer” should be broadly construed to include any of these types of pointers, indicators and items, whether now in use or developed for use with future user interfaces.

While certain components of the eye gaze device 32 (e.g., the eye data acquisition computer 38) may be integrated with the stimulus computer 42, it may be advantageous in some cases to have two separate computing devices. For instance, a user may have a portable eye gaze device to enable the user to connect the eye gaze device to a number of different stimulus computers that may be dispersedly located.

As described above, certain embodiments of the disclosed system and method are suitable for use with the less intrusive (e.g., passive) remote EGT devices commercially available to reduce jitter errors through a unique built-in neural network design. Other embodiments may utilize other EGT devices, such as those having head-mounted components. In either case, eye gaze coordinates, which may be sent to the computer interface where they are normalized into mouse coordinates, are passed through a trained neural network to reduce any error from the ubiquitous jitter of the mouse cursor due to eye movement. In some embodiments, a visual graphic interface is also provided to train the system to adapt to the user. In addition, a virtual “on-screen” keyboard and a speech (voice-control) interface may be integrated with the EGT aspects of the system to form a multimodal HCl system that adapts to the user to yield a user-friendly interface.

Embodiments of the disclosed system and method may be implemented in hardware or software, or a combination of both. Some embodiments may be implemented as computer programs executing on programmable systems comprising at least one processor, a data storage system (including volatile and non-volatile memory and/or storage elements), at least one input device, and at least one output device. Program code may be applied to input data to perform the functions described herein and generate the output information provided or applied to the output device(s). As used herein, the term “processor” should be broadly read to include general or special purpose processing system or device, such as, for example, one or more of a digital signal processor (DSP), a microcontroller, an application specific integrated circuit (ASIC), or a microprocessor.

The programs may be implemented in a high-level procedural or object-oriented programming language to communicate with, or control, the processor. The programs may also be implemented in assembly or machine language, if desired. In fact, practice of the disclosed system and method is not limited to any particular programming language, which in any case may be a compiled or interpreted language.

The programs may be stored on any computer-readable storage medium or device (e.g., floppy disk drive, read only memory (ROM), CD-ROM device, flash memory device, digital versatile disk (DVD), or other storage device) readable by a general or special purpose processor, for configuring and operating the processor when the storage media or device is read by the processor to perform the procedures described herein. Embodiments of the disclosed system and method may also be considered to be implemented as a machine-readable storage medium, configured for use with a processor, where the storage medium so configured causes the processor to operate in a specific and predefined manner to perform the functions described herein.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A method of configuring a human-computer interface system having an eye gaze device that generates eye gaze data to control a display pointer, the method comprising the steps of:
selecting a user profile from a user profile list to access an artificial neural network to address eye jitter effects arising from controlling the display pointer with the eye gaze data;
training the artificial neural network to address the eye jitter effects using the eye gaze data generated during a training procedure; and,
storing customization data indicative of the trained artificial neural network in connection with the selected user profile.

2. The method of claim 1, further comprising the step of customizing the training procedure via a user-adjustable parameter of a data acquisition phase of the training procedure.

3. The method of claim 2, wherein the user-adjustable parameter comprises a time period for the training data acquisition procedure.

4. The method of claim 2, wherein the user-adjustable parameter comprises a target object trajectory for the training data acquisition procedure.

5. The method of claim 2, wherein the user-adjustable parameter comprises a target object size for the training data acquisition procedure.

6. The method of claim 1, wherein the training step comprises the step of averaging position data of a target object for each segment of a training data acquisition phase of the training procedure to determine respective target data points for the training procedure.

7. The method of claim 1, further comprising the step of generating a performance assessment of the trained artificial neural network to depict a degree to which the eye jitter effects are reduced via application of the trained artificial neural network.

8. The method of claim 7, wherein the performance assessment generating step comprises providing information regarding pointer trajectory correlation, pointer trajectory least square error, pointer trajectory covariance, pointer jitter, or successful-click rate.

9. The method of claim 8, wherein the information provided regarding pointer jitter is determined based on a comparison of a straight line distance between a pair of target display positions and a sum of distances between pointer positions.

10. The method of claim 1, further comprising the step of storing vocabulary data in the selected user profile to support an on-screen keyboard module of the human-computer interface system.

11. The method of claim 1, further comprising the step of providing a speech recognition module of the human-computer interface system.

12. The method of claim 1, further comprising the step of selecting an operational mode of the human-computer interface system in which the display pointer is controlled by the eye gaze data without application of the artificial neural network.

13. The method of claim 1, wherein the selected user profile is a general user profile not associated with a prior user of the human-computer interface system.

14. The method of claim 1, wherein the selecting step comprises the steps of creating a new user profile and modifying the profile list to include the new user profile.

15. A computer program product stored on a computer-readable medium for use in connection with a human-computer interface system having an eye gaze device that generates eye gaze data to control a display pointer, the computer program product comprising:
a first routine that selects a user profile from a user profile list to access an artificial neural network to address eye jitter effects arising from controlling the display pointer with the eye gaze data;
a second routine that trains the artificial neural network to address the eye jitter effects using the eye gaze data generated during a training procedure; and,
a third routine that stores customization data indicative of the trained artificial neural network in connection with the selected user profile.

16. The computer program product of claim 15, further comprising a fourth routine that customizes the training procedure via a user-adjustable parameter of a data acquisition phase of the training procedure.

17. The computer program product of claim 16, wherein the user-adjustable parameter comprises a time period for the data acquisition phase.

18. The computer program product of claim 16, wherein the user-adjustable parameter comprises a target object trajectory for the data acquisition phase.

19. The computer program product of claim 16, wherein the user-adjustable parameter comprises a target object size for the data acquisition phase.

20. The computer program product of claim 15, wherein the second routine averages position data of a target object for each segment of a training data acquisition phase of the training procedure to determine respective target data points for the training procedure.

21. The computer program product of claim 15, further comprising a fourth routine that generates a performance assessment of the trained artificial neural network to depict a degree to which the eye jitter effects are reduced via application of the trained artificial neural network.

22. The computer program product of claim 21, wherein the fourth routine provides information regarding pointer trajectory correlation, pointer trajectory least square error, pointer trajectory covariance, pointer jitter, or successful-click rate.

23. The computer program product of claim 22, wherein the information provided regarding pointer jitter is determined based on a comparison of a straight line distance between a pair of target display positions and a sum of distances between pointer positions.

24. The computer program product of claim 15, wherein the selected user profile is a general user profile not associated with a prior user of the human-computer interface system.

25. The computer program product of claim 15, wherein the first routine creates a new user profile and modifies the user profile list to include the new user profile such that the selected user profile is the new user profile.

26. A human-computer interface system, comprising:
a processor;
a memory having parameter data for an artificial neural network stored therein;
a display device to depict a pointer;
an eye gaze device to generate eye gaze data to control the pointer; and,
an eye gaze module to be implemented by the processor to apply the artificial neural network to the eye gaze data to address eye jitter effects;
wherein the eye gaze module comprises a user profile management module to manage the parameter data stored in the memory in connection with a plurality of user profiles to support respective customized configurations of the artificial neural network.

27. The human-computer interface system of claim 26, wherein the eye gaze module is configured to operate in a first mode in which the eye gaze data is utilized to control the pointer via operation of the artificial neural network in accordance with a current user profile of the plurality of user profiles, and a second mode in which the eye gaze data is utilized by the user profile management module to manage the parameter data for the current user profile.

28. The human-computer interface system of claim 26, wherein the user profile management module modifies the parameter data to reflect results of a retraining of the artificial neural network in connection with a current user profile of the plurality of user profiles.

29. The human-computer interface system of claim 26, wherein the eye gaze module is configured to provide an optional mode in which the eye gaze data is utilized to generate the control data without application of the artificial neural network.

30. The human-computer interface system of claim 26, wherein implementation of the eye gaze module comprises a training data acquisition phase having a user-adjustable time period.

31. The human-computer interface system of claim 26, wherein implementation of the eye gaze module comprises a training data acquisition phase during which position data for a target object is averaged over a predetermined time segment prior to use in training the artificial neural network.

32. The human-computer interface system of claim 26, wherein implementation of the eye gaze module comprises a training data acquisition phase during which movement of a target object is modified to customize the training data acquisition phase.

33. The human-computer interface system of claim 26, wherein implementation of the eye gaze module comprises a training data acquisition phase during which a size of a target object is modified to customize the training data acquisition phase.

34. The human-computer interface system of claim 26, wherein the eye gaze module conducts a performance evaluation assessment to determine a degree to which the eye jitter effects are reduced via application of the artificial neural network.

35. The human-computer interface system of claim 26, wherein the user profile management module is automatically initiated at startup of the eye gaze module.

36. The human-computer interface system of claim 26, further comprising an on-screen keyboard module to be implemented by the processor to provide a customized word list based on a current user profile of the plurality of user profiles.

37. The human-computer interface system of claim 26, further comprising a speech recognition module to be implemented by the processor.
